(19) United States
(12) Patent Application Publication
(10) Pub. No.: US 2010/0080205 A1
(43) Pub. Date: Apr. 1, 2010

(54) RATE RECOVERY MECHANISIM, METHOD AND SYSTEM FOR A WLAN-BLUETOOTH COEXISTANCE SYSTEM

(75) Inventors: Olaf Hirsch, Sunnyvale, CA (US); Dietmar Knittel, Dresden (DE); Hans-Joachim Zimmer, Ottendorf-Oknilla (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/598,631

(22) PCT Filed: May 17, 2008
(86) PCT No.: PCT/IB08/51946

§ 371 Date: Nov. 3, 2009

Related U.S. Application Data
(60) Provisional application No. 60/939,011, filed on May 18, 2007.

(51) Int. Cl. H04W 84/12; H04B 7/00

(52) U.S. Cl. 370/338; 455/41.2

(57) ABSTRACT

In accordance with the invention, a method and system relating to the rate recovery mechanism in a Wireless Local Area Network (WLAN) and Bluetooth coexistence system is provided.

### BACKGROUND

In today's world, the use of Wireless Personal Area Networks (WPANs) is becoming increasingly popular because of the flexibility and convenience in connectivity they provide. WPAN systems, such as those based on Bluetooth technology, provide wireless connectivity to peripheral devices and/or mobile terminals by providing short distance wireless links that allow connectivity within a specific range; for instance a 10-meter range. In contrast to WPAN systems, Wireless Local Area Networks (WLANs) provide connectivity to devices that are located within a slightly larger geographical area, such as the area covered by a building or a campus, for example. WLAN systems are based on IEEE 802.11 standard specifications, typically operating within a 100-meter range, and are generally utilized to supplement the communication capacity provided by traditional wired local area networks (LANs) installed in the same geographical area as the WLAN system.

In some instances, WLAN systems may be operated in conjunction with WPAN systems to provide users with an enhanced overall functionality. However, collocation interferences arise in such instances, because of the proximity of the two transceivers. In such cases, signals being transmitted from one device typically cause the other device's receiver to saturate, thus rendering it desensitized.

If both the devices (Bluetooth device and WLAN device) operate in the same unlicensed ISM band at 2.4 GHz, both the devices transmit and receive at the time and frequency thus jeopardizing effective communication at overlapping frequencies. In such instances, transmission typically has to be scheduled in such a way as to avoid simultaneous transmission. This transmission scheduling is typically performed by employing techniques known as Packet Traffic Arbitration (PTA) techniques. The PTA algorithm prevents WLAN from transmitting at certain points in time when the Bluetooth device needs to receive or transmit. For example, if a person is making a phone call through a Bluetooth headset and at the same time is uploading/downloading emails using WLAN, the PTA algorithm prevents the WLAN from transmitting when the Bluetooth needs to receive or transmit so that a clear voice is transmitted through the Bluetooth headset.

An Access Point (AP) is a device that connects wireless communication devices together to form a wireless network. In standard communication protocols, Access Points send frames to the Stations (STA) and the STA send an Acknowledgement (ACK) upon successful reception of a frame. If PTA is used for WLAN Bluetooth coexistence, Bluetooth can suppress transmissions of the collocated WLAN device. The possible frames that could be suppressed are ACK frames. Typically, these frames are sent as a response to a frame from the AP. If the ACK frames are suppressed, the access point could wrongly conclude that its frame got corrupted due to a noisy channel, or weak signal, and retransmit the same frame at a lower data transmission rate. Frames with lower data rate have a higher probability of corruption by the collocated Bluetooth, making it even more likely that an AP would further reduce its data transmission rate. This ends in a spiral until the access point has reached the lowest data transmission rate. This behavior impacts the throughput of the WLAN system tremendously.

A rate recovery mechanism is a means to make an AP start with higher data transmission rates once it reduces its data transmission rate because of the reception of corrupted set of frames. The rate recovery mechanism is explained as follows: When a Wireless Local Area Network Station (WLAN STA) receiving frames at a predetermined data transmission rate detects a certain number of frames transmitted from the AP at a reduced data transmission rate, the WLAN STA transmits a de-authentication frame to the AP. Due to the de-authentication frame, the AP discards information about the WLAN STA (e.g., the data transmission rate of the WLAN STA). Following the sending of the de-authentication frame, the WLAN STA resends an authentication frame and the AP starts transmitting at its highest data transmission rate.

If, after reset of the data transmission rate in the AP, the initial frame is not acknowledged because of low signal strength, some APs will send the next frame at the lowest possible data transmission rate, causing the rate fallback to occur again.

### SUMMARY

In accordance with the invention, a method and system relating to the rate recovery mechanism in a Wireless Local Area Network (WLAN) and Bluetooth coexistence system is provided.

### BRIEF DESCRIPTION OF DRAWINGS

FIG. 1 is a flow diagram illustrating the sequence of steps in a method for implementing an improved rate recovery mechanism in an embodiment in accordance with the invention;

FIG. 2 is a flow diagram illustrating the sequence of steps in a method for implementing an improved rate recovery mechanism according to an embodiment in accordance with the invention;

FIG. 3 is a flow diagram illustrating the sequence of steps in a method for implementing an improved rate recovery mechanism when the re-association between WLAN STA and AP is performed at a low data transmission rate according to an embodiment in accordance with the invention; and

FIG. 4 illustrates certain frame transmissions between a WLAN STA and an AP according to an embodiment in accordance with the invention.

### DETAILED DESCRIPTION

Embodiments in accordance with the invention described herein provide a method and system for implementing an improved rate recovery mechanism in a WLAN and Bluetooth coexistence system. As described below, the invention provides for the functioning of Access Points (AP) that fall back to a lower data transmission rate when the initial frame exchange between an AP and the WLAN STA fails, after resetting the AP as part of a rate recovery mechanism.

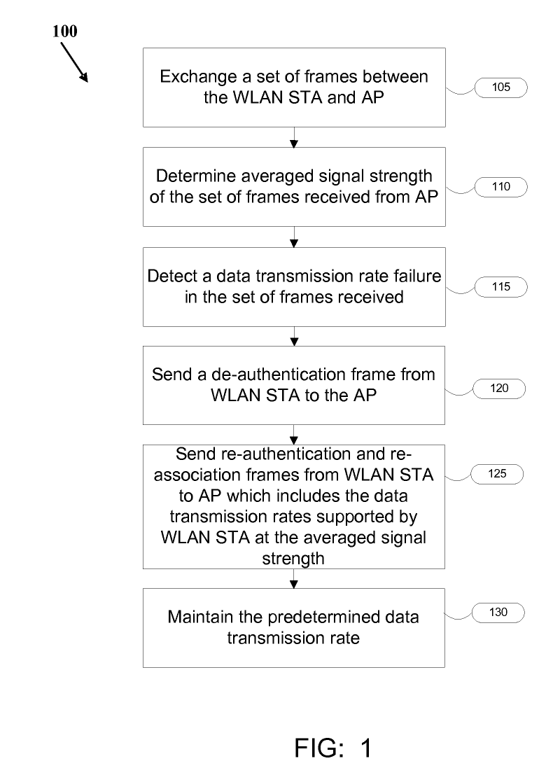

FIG. 1 depicts a flow diagram at 100 illustrating the sequence of method steps in an improved rate recovery mechanism in accordance with an embodiment in accordance with the invention. In conducting a wireless communication, a set of frames transmitted at a predetermined data transmission rate is exchanged between an AP and a WLAN STA in a WLAN/Bluetooth coexistence system, and the averaged signal strength of the set of frames received is determined. Should there be a failure of communication resulting in a rate fallback (AP lowering its data transmission rate to its lowest rate), the WLAN STA detects the rate failure and sends a de-authentication frame to the AP. After the de-authentication frame is sent to the AP, the WLAN STA sends a re-authentication frame and a re-association frame. In the re-association frame the WLAN STA encodes the data transmission rate (Physical Layer data transmission rate (PHY rate)) that it supports based upon the previously determined averaged signal strength.

In one embodiment in accordance with the invention, as a first step 105, a set of frames transmitted at a predetermined data transmission rate is exchanged between the AP and the WLAN STA. In a second step 110, the WLAN STA determines the averaged signal strength of the set of frames received from the Access Point (AP). If the WLAN STA subsequently detects a data transmission rate failure in the set of frames received from the AP (step 115), the WLAN STA sends a de-authentication frame to the AP in step 120. In response to the de-authentication frame, the AP discards any previous information about the WLAN STA. After sending the de-authentication frame (step 125), the WLAN STA then sends a re-association frame and re-authentication frame to the AP which includes the data transmission rate(s) supported by the WLAN STA at the previously averaged signal strength. This is to say that the data transmission rates supported by WLAN STA are encoded in the re-association frame. In response (step 130), the AP transmits at the predetermined data transmission rate(s) supported by the WLAN. Thus, by limiting the allowed data transmission rate(s), the initial frames sent from the AP after reset will be at a rate supported and acknowledged by the WLAN without further reduction of the data transmission rate by the AP.

If the WLAN STA determines that it will not be able to receive frames at higher data transmission rates, it will indicate that those higher data transmission rates are not supported. However, in order to assure interoperability with a wide range of AP transmission rates, the WLAN STA includes the option to support the higher data transmission rates if the signal strength is high enough. Moreover, if the WLAN STA determines that the signal strength has increased sufficiently to enable it to receive the set of frames at the highest data transmission rates, it can re-associate with the AP and include the higher data transmission rates in the re-association frame.

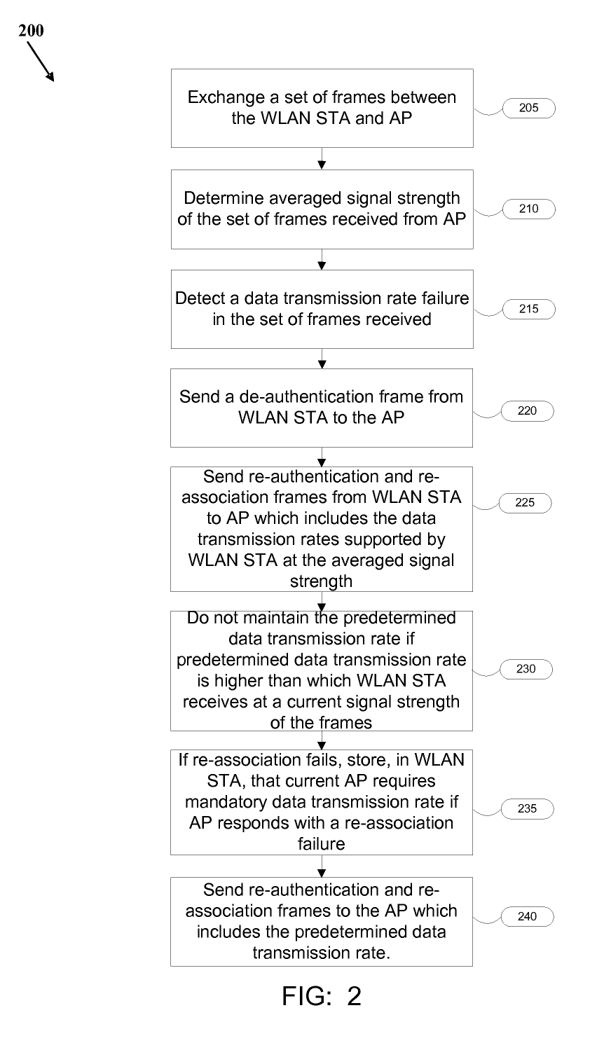

FIG. 2 is a flow diagram (200) illustrating the sequence of steps in a method for implementing an improved rate recovery mechanism according to an embodiment in accordance with the invention. In a first step shown at 205, a set of frames transmitted at a predetermined data transmission rate is exchanged between an AP and a WLAN STA. As indicated in step 210, the WLAN determines the averaged signal strength of the set of frames received from the AP. If the averaged signal strength is acceptable, an acknowledgement (ACK) is sent to the AP. If however, as indicated in step 215, the WLAN STA detects a data transmission rate failure (an unacceptable averaged signal strength for the transmitted data rate) in the set of frames received from the AP, it will send a de-authentication frame to the AP (step 220) causing the AP to discard the information it has about the WLAN STA. As stated in step 225, the WLAN then sends a re-authentication and a re-association frame to the AP which includes the data transmission rate or rates supported by the WLAN STA at the averaged signal strength. If as indicated in step 230 the WLAN determines that the AP is thereafter not transmitting at a supported data transmission rate, it will instruct the AP to discontinue the transmission. If the AP continues to transmit at a transmission rate that is higher than that which the WLAN STA can receive at the current signal strength of the frames, re-association will fail (step 235), and the WLAN STA will store in memory the fact that the higher data transmission rate is required. In step 240, the WLAN sends a re-authentication frame and a re-association frame to the AP which includes an indication that the higher data transmission rate is not supported.

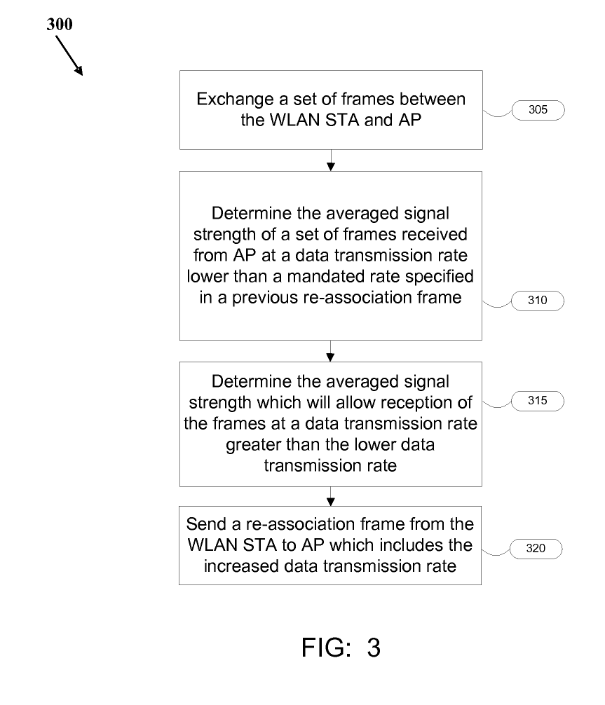

FIG. 3 is a flow diagram illustrating the sequence of steps in a method 300 for an improved rate recovery mechanism when a re-association between WLAN STA and AP is performed at a low data transmission rate according to an embodiment in accordance with the invention. In this embodiment, in step 305 a set of frames is exchanged between the AP and the WLAN STA at a data transmission rate lower than the rate specified in a previous re-association frame sent to the AP based on a previously determined averaged signal strength. In step 310 a new averaged signal strength of the set of frames received from the AP at the lower data transmission rate is determined, and in step 315, the new averaged signal strength is used to determine an increased data transmission rate, greater than the lower data transmission rate, at which the reception of frames will be allowed. In step 320, a re-association frame is sent from the WLAN STA to the AP which includes the increased data transmission rate.

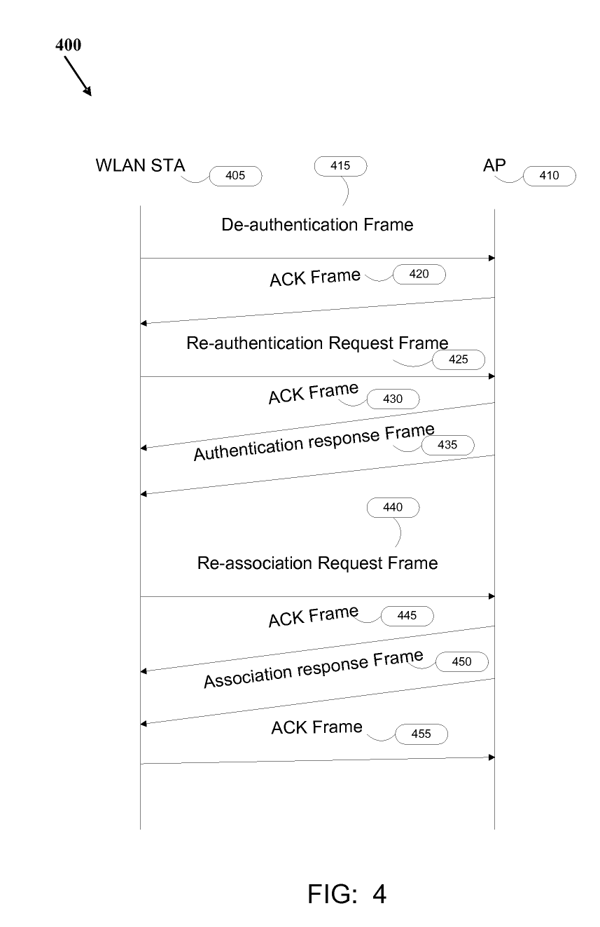

FIG. 4 illustrates at 400 certain frame transmissions between the WLAN STA 405 and the AP 410 according to an embodiment in accordance with the invention. When the WLAN STA 405 detects a data transmission rate failure, a de-authentication frame 415 is sent to the AP 410. AP 410 acknowledges the reception of de-authentication frame 415 by sending an acknowledgement (ACK) frame 420 to the WLAN STA 405. Upon receiving the ACK frame 420, WLAN STA 405 sends a re-authentication request frame 425 to the AP 410. AP 410 acknowledges the reception of re-authentication frame 425 by an ACK frame 430 and sends the authentication response frame 435 to the WLAN STA 405. Further, WLAN STA 405 sends re-association request frame 440 to the AP 410. AP 410 receives the re-association request frame 440 and sends the ACK frame 445, and also sends the association response frame 450 to the WLAN STA 405. Within the exchange of re-association request frame 440 and association response frame 450, both the WLAN STA 405 and AP 410 encode the data transmission rates they support. Upon receiving the association response frame 450 from the AP 410, WLAN STA 405 acknowledges the reception of the association response frame 450 by sending an ACK frame 455 to the AP 410.

Embodiments in accordance with the invention can be applied to WLAN and Bluetooth coexistence implementations that use Packet Traffic Arbitration (PTA) and the rate recovery mechanism. Embodiments in accordance with the invention can be implemented in a BGW211 WLAN chip.

The forgoing description sets forth numerous specific details to convey a thorough understanding of the invention. However, it will be apparent to one skilled in the art that the invention may be practiced in ways not limited to these specific details. Well-known features are sometimes not described in detail in order to avoid obscuring the invention. Other variations and embodiments are possible in light of the above teachings, and it is thus intended that the scope of invention not be limited by this detailed description, but only by the following Claims.

1. A rate recovery method comprising:
exchanging a set of frames at a predetermined data transmission rate between an access point and a wireless local area network station in a wireless local area network and bluetooth coexistence system;
determining an averaged signal strength of said set of frames;
detecting a data transmission rate failure in the set of frames received from the access point;
sending a de-authentication frame from the wireless local area network station to the access point; and
sending a re-authentication frame and a re-association frame from the wireless local area network station to the access point including the data transmission rate at which the wireless local area network station can receive at said averaged signal strength.

2. A rate recovery method as recited in claim 1, wherein if the wireless local area network station detects a data transmission rate higher than said predetermined data transmission rate which cannot be received, an indication is sent to the access point indicating that said high data transmission rate is not supported.

3. A rate recovery method as recited in claim 1, wherein the data transmission rate supported by the wireless local area network station is encoded in said re-association frame.

4. A rate recovery method as recited in claim 1, whereby the wireless local area network station resets the data transmission rate of the access point using data encoded in said re-association frame.

5. A rate recovery method as recited in claim 4, whereby the wireless local area network station receives a set of frames from the access point after it is reset.

6. A transmission rate recovery method comprising:
exchanging a set of frames at a predetermined data transmission rate between a wireless local area network station and an access point in a wireless local area network and bluetooth coexistence system;
determining an averaged signal strength of said set of frames received from said access point by said wireless local area network station;
detecting a data transmission rate failure in the set of frames received from the access point;
sending a de-authentication frame from the wireless local area network station to the access point; and
sending a re-authentication frame and re-association frame from the wireless local area network station to the access point, wherein said re-association frame includes the data transmission rate(s) which the wireless local area network station can receive at said averaged signal strength.

7. A transmission rate recovery method as recited in claim 6
wherein said data transmission rate(s) is not maintained if said data transmission rate(s) is higher than that which the wireless local area network station can receive at a current averaged signal strength of the set of frames; and
wherein if the access point responds with an association failure, the wireless local area network station stores the fact that said access point requires said higher data transmission rate(s) and sends said re-association frame which includes an indication that said wireless local area network station can not support said higher data transmission rate.

8. A transmission rate recovery method as recited in claim 6, wherein the data transmission rate supported by the wireless local area network station is encoded in said re-association frame.

9. A transmission rate recovery method as recited in claim 6, whereby the wireless local area network station resets the data transmission rate of the access point.

10. A transmission rate recovery method as recited in claim 9, whereby the wireless local area network station receives a set of initial frames from the access point after said reset.

11. A method of implementing a data transmission rate recovery mechanism comprising:
exchanging a set of frames at a predetermined data transmission rate between an access point and a wireless local area network station in a wireless local area network and bluetooth coexistence system;
determining an averaged signal strength of said set of frames received from said access point to said wireless local area network station, wherein a previous re-association frame is sent from the wireless local area network station to the access point at a reduced data transmission rate than said determined data transmission rate;
detecting said averaged signal strength which allows the reception of said set of frames from the access point at an increased data transmission rate than said reduced data transmission rate; and
sending a re-association frame from the wireless local area network station to the access point following to said detecting step which includes said increased data transmission rate.

12. A method of implementing a data transmission rate recovery mechanism as recited in claim 11, wherein the data transmission rates supported by the wireless local area network station are encoded in said re-association frame.

13. A method of implementing a data transmission rate recovery mechanism as recited in claim 11, whereby the wireless local area network station resets the access point's data transmission rate.

14. A method of implementing a data transmission rate recovery mechanism as recited in claim 13, whereby the wireless local area network station receives a set of initial frames from the access point after said reset.

15. A system comprising:
a collocated Bluetooth device and a wireless local area network device for enabling wireless communication through Bluetooth transmission and wireless local area network transmission; and
a wireless local area network station for scheduling wireless local area network transmissions including a set of frames between an access point and said wireless local area network station;
wherein said wireless local area network station includes
a memory for maintaining an averaged signal strength of the set of frames received from said access point;
a means for detecting a data transmission rate failure in said set of frames received from the access point;
a means for sending a de-authentication frame from the wireless local area network station to the access point; and
a means for sending a re-association frame from the wireless local area network station to the access point which includes the data transmission rates which the wireless local area network station can receive at said averaged signal strength.

16. A system as recited in claim 15, whereby the wireless local area network station resets the access point's data transmission rate.

17. A system as recited in claim 15, whereby the wireless local area network station receives a set of initial frames from the access point after said reset.
